(19) United States
(12) Patent Application Publication
(10) Pub. No.: US 2016/0190718 A1
(43) Pub. Date: Jun. 30, 2016

(54) BLIND ELECTRICAL CONNECTOR BETWEEN PRINTED CIRCUIT BOARD AND SOLENOID MEMBER

(71) Applicant: BorgWarner Inc., Auburn Hills, MI (US)

(72) Inventor: David VanZuilen, Fremont, IN (US)

(21) Appl. No.: 14/587,564

(22) Filed: Dec. 31, 2014

(51) Int. Cl. H01R 12/70; F01P 5/12; H02K 7/108; F04D 29/18; F04D 29/40; H02K 11/00; H01R 13/405; F04D 13/06

(52) U.S. Cl. CPC H01R 12/7076; H01R 13/405; F01P 5/12; F04D 13/0693; F04D 29/18; F04D 29/406; H02K 11/0094; H02K 11/0073; H02K 7/1085

(57) ABSTRACT

An electrical connector member for electrically connecting together two components of a device, such as a vehicle engine accessory. The connector member has locating members at each end, together with pairs of electrical contacts. The connector member can electrically connect a printed circuit board to a solenoid member or other components in a blind manner.

### TECHNICAL FIELD

The present invention relates to blind electrical connectors, and more particularly, to such connectors for vehicle accessories, such as coolant pumps.

### BACKGROUND

Blind connectors for electrical devices, such as vehicle engine accessories, are known today. Blind electrical connectors are utilized, for example, when it is necessary to electrically connect two parts or components and the connection step or process cannot be viewed or accomplished directly due to intervention of other parts or components. The connectors are provided in various shapes and sizes depending on the type and size of the electrical devices or accessories with which they are used.

With the emphasis today on making vehicles smaller, lighter and more efficient, but with the same reliability and durability, it is important to provide electrical connectors that are smaller and lighter and yet maintain their efficiency, durability and effectiveness for the life of the accessory or vehicle.

It is an object of the present invention to provide an improved blind electrical connector for use with electrical devices, such as vehicle engine accessories, and for coolant pumps in particular.

### SUMMARY OF THE INVENTION

The blind electrical connector in accordance with a preferred embodiment of the invention includes an elongated body and electrical contacts and locating members at each end. The electrical contacts preferably comprise pin members, such as compliant pin members. The locating members preferably comprise elongated post members which are adapted to mate with corresponding openings or key slots in the electrical component and/or printed circuit board (PCB). The locating members can center the connector during the attachment or assembly procedure.

In use, the connector can extend between and electrically connect an electrical component, such as a solenoid member, to a PCB. During assembly of vehicle accessory devices, such as coolant pumps, the connector can be connected to a PCB and then blindly connected to an electrical component, such as a solenoid, or can be connected first to an electrical component and then blindly connected to a PCB. The invention allows quick, easy and secure electrical connections and attachments.

Further features, benefits and advantages of the invention will become apparent from the following detailed description of the invention, together with the drawings and appended claims.

### BRIEF DESCRIPTION OF THE DRAWINGS

FIG. 1 depicts a cooling pump in which an embodiment of the inventive blind electrical connector can be utilized.

FIG. 2 is an exploded view of the cooling pump shown in FIG. 1.

FIG. 3 is a cross-sectional view of the coolant pump of FIG. 1.

FIG. 4 is a perspective view of a blind electrical connector in accordance with a preferred embodiment of the invention.

FIG. 5 is an enlarged view of the blind connector shown in FIG. 4 being connected to a printed circuit board.

FIGS. 6-9 are enlarged views of the blind connector shown in FIG. 4 being connected to a solenoid member.

### DESCRIPTION OF THE PREFERRED EMBODIMENTS

For purposes of description of the inventive blind electrical connector, it will be described in use with a coolant pump, particularly a dual mode coolant pump. This is not to be taken as limiting the use of the invention, however, but only as a means for describing its features and operation. The inventive electrical connector could be used in any electrical device, such as a vehicle accessory, where a blind electrical connection is needed.

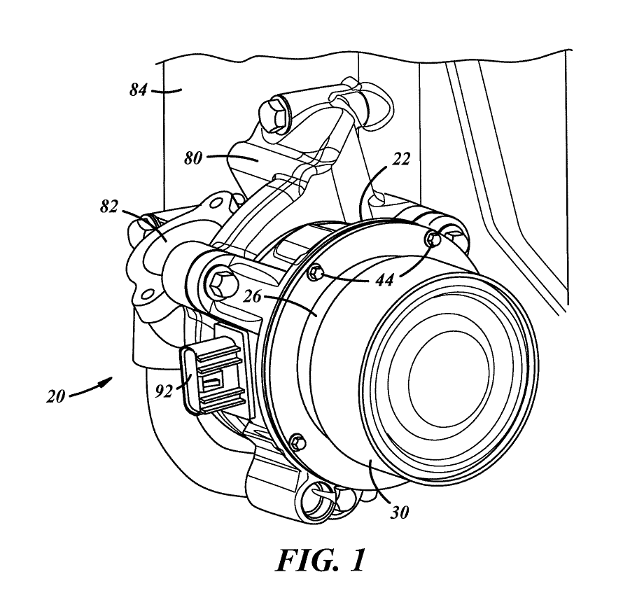

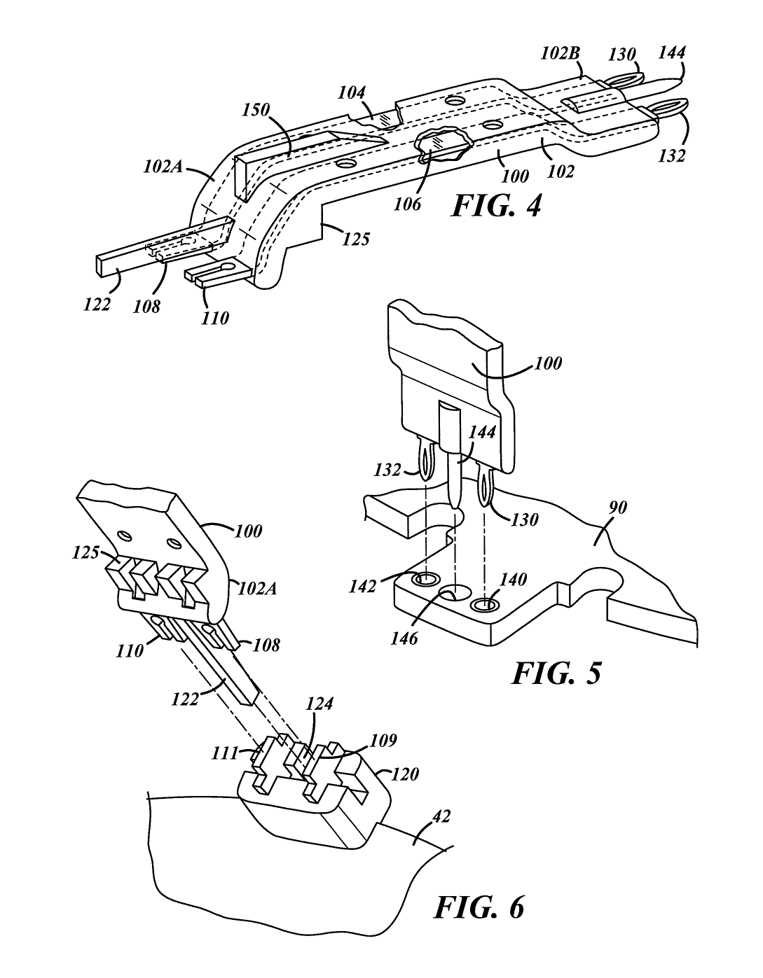

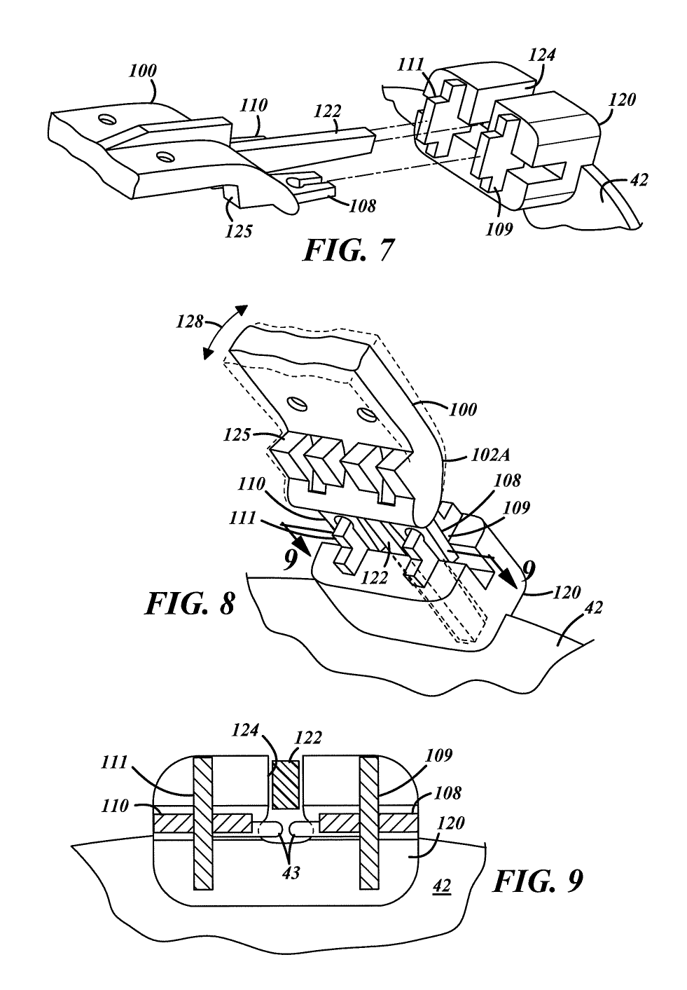

The preferred embodiment of the blind electrical connector 10 is shown in FIGS. 1-8. FIG. 4 is a perspective view of the preferred embodiment of the connector, while the rest of the Figures depict its use in a coolant pump 20.

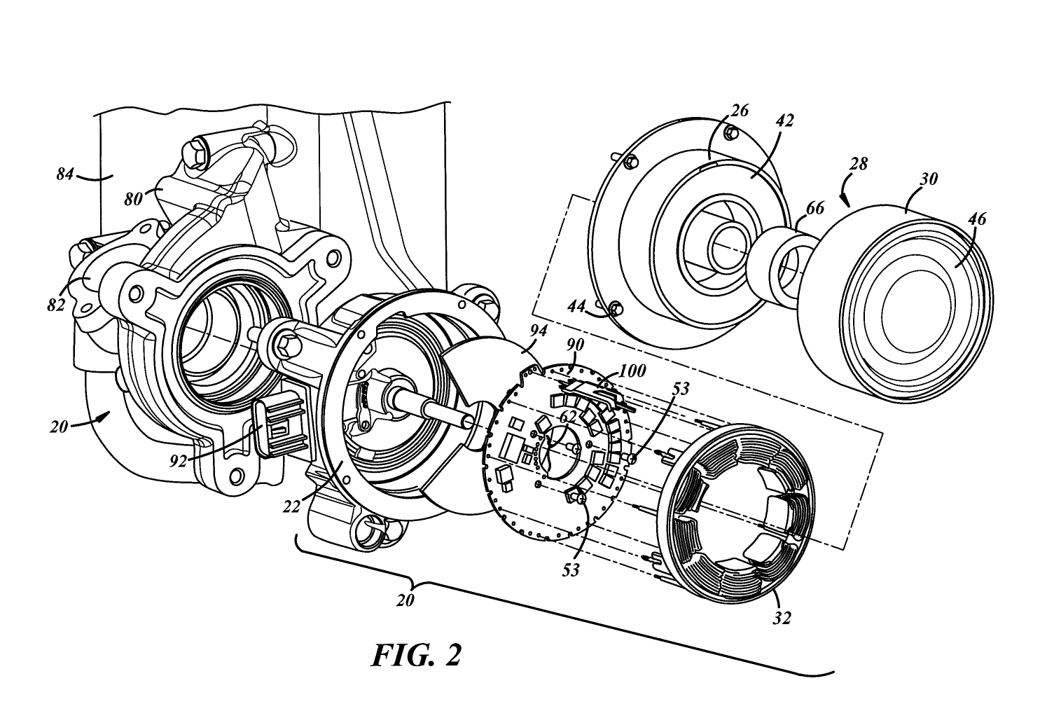

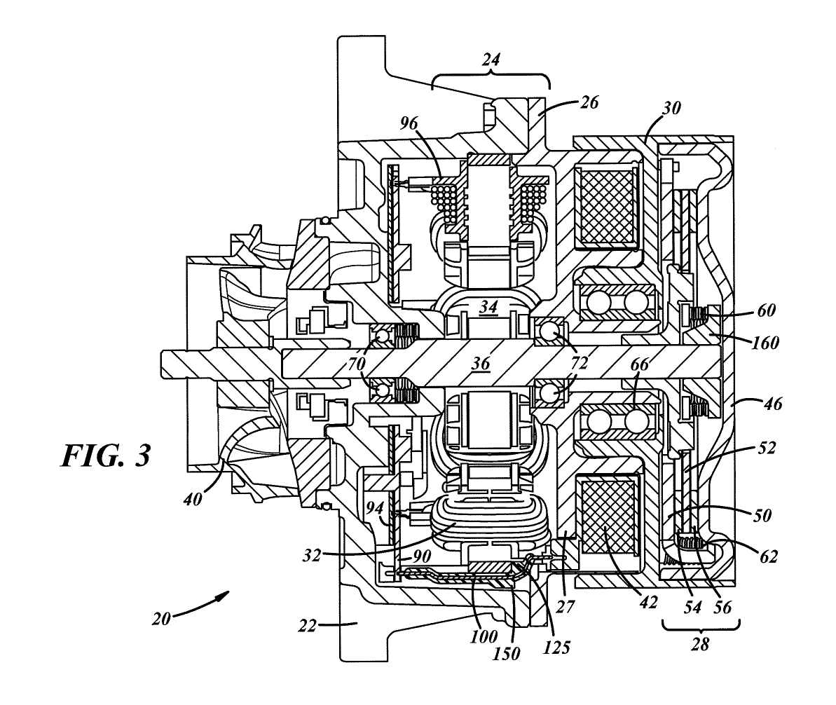

An exploded view of pump 20 is shown in FIG. 2, and a cross-sectional view is shown in FIG. 3. The pump 20 includes a housing 22, an electric motor 24, a solenoid housing 26, a friction clutch mechanism 28, and a pulley member 30. The pulley member 30 is adapted to be rotated by an engine belt (not shown) in a conventional manner The pulley member is rotated by the engine at “input speed”.

A preferred dual mode coolant pump with which the inventive blind connector can be utilized, is disclosed and discussed in detail in U.S. patent application Ser. No. 14/149,683, filed on Jan. 7, 2014, entitled “Accessory Drive With Friction Clutch and Electric Motor”. The disclosure of that patent application is hereby incorporated herein by reference.

The electric motor 24 is preferably a brushless DC motor and includes a stator member 32 and a rotor member 34. The rotor member is attached to the impeller shaft 36 which is positioned centrally in the housing 22. An impeller member 40 is attached to the impeller shaft 36 and rotates with it to circulate coolant in a vehicle engine.

The housing 22 is preferably made of a metal material with good thermal conductivity, such as aluminum. A solenoid member 42 is positioned in the solenoid housing 26 which is connected to the housing 22, preferably by fasteners, such as bolts 44. The solenoid housing 26 is preferably made of a metal material, such a low carbon steel. A cover member 46 is positioned on the end of the solenoid housing 26 and is affixed to the pulley member 30.

When the solenoid is energized, that is, when electric current is applied to it, the solenoid deactivates the friction clutch mechanism 28. The friction clutch mechanism 28 includes an armature member 50, which is made of a magnetic material, and a friction plate member 52. Abrasive friction members 54 and 56 are fixedly attached on opposite sides of the friction plate member. The friction members can be of any conventional type and of any size and shape, such as annular rings or a plurality of separate pieces of conventional friction material. Spring members 60, such as a wave spring, biases the friction plate member away from contact with the cover member 46. Spring members 62, such as a plurality of coil spring members, bias the armature member from contact with the pulley member 30.

When the solenoid member is energized (a/k/a “activated”), the armature member 50 is pulled axially into contact with the pulley member 30 which in turn prevents the friction members on the friction plate member from contacting the cover member 46. During this operation, the pulley member runs freely on bushing member 66.

During normal operation of the coolant pump, the impeller shaft and impeller are rotated by the electric motor 24. This supplies sufficient circulation and cooling of the coolant fluid under most driving periods of a vehicle. When additional coolant flow is needed, such as when the vehicle pulls a heavy load and more cooling is required, the shaft is rotated mechanically at input speed. For this purpose, the solenoid member is deenergized (a/k/a deactivated) which allows the armature member 50 to shift axially toward the cover member 46. This allows the friction lining 56 on the friction plate member 52 to contact the cover member. Since the cover member 46 is attached to the pulley member and rotates with it, this provides rotation of the coolant shaft at input speed.

The components, including the solenoid member, armature member, friction plate member, friction linings, and biasing spring members, are all collectively part of the friction clutch mechanism 28.

The impeller shaft 36 is mounted in and rotatably supported in the coolant pump 20 by bearing members 70 and 72. The electric motor 24 is positioned on the shaft between the bearing members 70 and 72.

Additional description and details of the preferred dual mode coolant pump and its operation are contained in U.S. patent application Ser. No. 14/149,683.

The operation of the coolant pump 20 is controlled by control logic which receives data and information from an engine electronic control unit (“ECU”). The ECU receives data and information from a plurality of sensors, such as temperature sensors, and other ECUs within the vehicle. The coolant pump is thus operated to maintain the temperature of the coolant fluid within acceptable limits.

As shown in FIGS. 1 and 2, the coolant pump is attached to a housing 80 which has an inlet port 82 for coolant fluid and an outlet port (not shown) for passage of the coolant fluid into the engine block 84. When the impeller 40 is rotated by the dual mode coolant pump 20, the coolant liquid is pumped through the outlet port into and through the engine and the rest of the engine cooling system, and then returned to the coolant pump inlet port 82.

The electronics for the electric motor 24 and the solenoid member 42 are contained in a printed circuit board (“PCB”) 90. The PCB contains the electronic components which electrically control the operation of the electric motor 24 and solenoid member 42, including turning them ON and OFF. Power from the circuit board 90 is supplied through connector member 92. The connector member 92 has a plurality of lead wires that are connected to the PCB inside the housing 22. The lead wires include wires which provide power to the PCB and others which provide signals to operate the electric motor and solenoid member. The PCB is connected to the housing 22 by a plurality of fasteners 53.

A gap filler 94 is preferably positioned between the PCB and the inside wall of the housing 22. The gap filler conducts heat from the PCB into the aluminum housing so it can be dissipated into the coolant fluid.

Power to the electric motor is supplied from the PCB to the electric motor through lead frame member 96 and pin connectors 97. Power is supplied to the solenoid member 42 through blind electrical connector member 100.

The connector member 100 is best shown in FIGS. 3-9. The connector member 100 includes an elongated body member 102 made from a molded plastic material, such as Nylon. A pair of thin strips of electric wire leads 104 and 106, preferably made of copper or a copper alloy, are insert molded in the body member.

At one end 102A of the body member 102, forked contact members 108 and 110 are connected to the leads 104 and 106. Each of the contact members 108, 110, which are made of an electrically conductive metal material, have a pair of arm members. The arm members are adapted to be press fit over a transversely-oriented mating contract member 109, 111, as shown in FIGS. 6-9. Once the contact members 108, 110 are press fit over the contact members 109, 111, respectively, secure electrical connections are provided between the connector member 100 and the solenoid member 42. For this purpose, a small bobbin member 120 is attached to the solenoid member, with the ends of the coil wires 43 in the solenoid being securely attached to the contact members 109 and 111.

To aid in aligning and centering the mating pairs of contact members 108, 110, 109, and 111 for being pressed and secured together, a keying locator member 122 is provided on the end 102A of the body member. In addition, a keying slot 124 is provided in the bobbin member 120. The diameter of the locator 122 is also slightly larger than the width of the slot 124, such that the locator is press fit and held by friction in the slot. This also aids in mating the connector member 100 and solenoid member 42 is a blind manner and having them be securely connected together. As shown, the length of the locator member 122 is greater than the length of contact members 108 and 110.

The relationship between the locator member 122 and the slot member 124 when the locator is positioned and held in the slot is preferably such that the locator can rotate in the direction shown by arrow 128. This allows the connector member 100 to pivot transversely relative to the bobbin member 120 and solenoid member 42. Such movement can assist in positioning and mating the connector member to the bobbin member and thus to the solenoid member.

The connector member 100 has one or more shoulder members 125 (also called stop members). The shoulder members are adapted to contact the edge of metal strip member 35 on the outside perimeter of the stator member 42 (as shown in FIG. 3). This assists in properly positioning the connector member 100 when it is assembled and installed in the coolant pump 20.

At the other end 102B of the body member 102, contact pin members 130 and 132 are provided. These are also connected to the leads 104 and 106. Contact pin members 130, 132 have two curved side members that are attached at their distal ends. The side members are flexible and can be squeezed together.

The connector member is connected at its end 102B to the printed current board 90, as shown in FIG. 5. This also can be done in a blind manner. The contact members 130, 132 are positioned in openings 140, 142 in the PCB. The inside surfaces of the openings are coated with an electrically conductive metal material, such a copper or silver. The diameters of the openings 140, 142 are smaller than the width of the contact members 130, 132 such that when the connector member 100 is attached to the PCB, the side members are squeezed together. This provides a resistant force securely holding the connector member 100 to the PCB, and also securely making an electrical connection.

To aid in aligning and centering the contact members 130, 132 with the openings 140, 142, a keying locator member 144 is provided on the end 102B. A corresponding opening 146 is provided in the PCB for mating with the locator member 144. The relationship between the diameter of the locator member 144 and the diameter of the opening 146 is such that the locator member can be inserted easily in the opening. This can be a loose fit relationship or a weak press fit relationship. As shown, the length of the locator member 144 is greater than the length of contact members 130 and 132.

As shown in FIG. 4, a rib member 150 is provided on one side of the connector body member 102. The rib member rests against the inside of housing member 22 and assists in blind mating of the connector to the PCB. The rib member also provides additional stability to the connector when it is installed in position during assembly.

When the components of the coolant pump 20 are assembled, the connector member 92 is plugged into the housing member 22 and the PCB 90 is pressed in place, electronically connects the two components together. Then the connector member 100 is used to electrically connecting the solenoid member 42 with the PCB 90. This relationship is shown in FIG. 3. Since the PCB is installed first in the housing member 22, either alone or in subassembly with the stator member 32, the stator member is located between the PCB and the solenoid member 42. In addition, a solid transverse metal wall member 27 of the solenoid housing member 26 is located between the PCB and the solenoid member. Thus, the connector member 100 has to be mated and secured to either the PCB or the bobbin member 120 of the solenoid member 42 in a blind manner.

Once the solenoid member is assembled in place and connected to the PCB, the pulley member 30, friction clutch mechanism 28, impeller shaft member 36 and other components are installed and assembled as a dual mode accessory. A retainer member 160 is attached, such as by a press fit, to the end of the impeller shaft member, and then the cover member 46 is secured in place.

Thereafter, the coolant pump is connected to the fluid housing member 80 and other final assembly operations are done.

The inventive blind connector member provides the requisite secure electrical connections in the coolant pump and does so in a manner which facilitates making the assembly and connections in a blind manner. Although the invention is described herein with respect to its use in a dual mode coolant pump, persons of skill in the art would realize, and be able to use it, in other accessories or devices where similar blind electrical connections are necessary between components.

Although the invention has been described with respect to preferred embodiments, it is to be also understood that it is not to be so limited since changes and modifications can be made therein which are within the full scope of this invention as detailed by the following claims.

What is claimed is:

1. An electrical connector comprising:
an elongated body member having a first end and a second end;
at least one electrical lead positioned in said body member;
a first locator member positioned on said first send;
a second locator member positioned on said second end;
at least one first contact member positioned on said first end; and
at least one second contact member positioned on said second end.

2. The electrical connector member as described in claim 1 wherein said first locator member is an elongated rod member.

3. The electrical connector member as described in claim 1 wherein said second locator member is an elongated rod member.

4. The electrical connector member as described in claim 1 wherein said electrical lead is insert molded in said body member.

5. The electrical connector member as described in claim 1 wherein two electrical leads are positioned in said body member.

6. The electrical connector member as described in claim 1 wherein two first contact members are provided in said first end of said body member.

7. The electrical connector member as described in claim 6 wherein said first contact members each comprise complaint pin members.

8. The electrical connector member as described in claim 1 wherein two second contact members are provided on said second end.

9. The electrical connector member as described in claim 8 wherein said second contact members each comprise a pair of arm members and are adapted to mate in a press-fit relationship with a transverse contact member.

10. A coolant pump comprising:
a first housing member;
a printed circuit board member positioned in said first housing member;
a second housing member attached to said first housing member;
a solenoid member positioned in said second housing member;
an electrical connector member electrically connecting said solenoid member to said printed circuit board.

11. The coolant pump as described in claim 10, said connector member comprising:
an elongated body member having a first end and a second end;
at least one electrical lead positioned in said body member;
a first locator member positioned on said first send;
a second locator member positioned on said second end;
at least one first contact member positioned on said first end; and
at least one second contact member positioned on said second end.

12. The coolant pump as described in claim 10 further comprising a stator member positioned between said printed circuit board and said solenoid member.

13. The coolant pump as described in claim 10 further comprising a mounting member attached to said solenoid member, and said connector member being connected to said mounting member.

14. The coolant pump as described in claim 13 wherein said mounting member has a key slot for mating with one of said first and second locator members.

15. The coolant pump as described in claim 11 wherein two first contact members are provided in said first end of said body member.

16. The coolant pump as described in claim 15 wherein said first contact members each comprise complaint pin members.

17. The coolant pump as described in claim 11 wherein two second contact members are provided on said second end.

18. The coolant pump as described in claim 17 wherein said second contact members each comprise a pair of arm members and are adapted to mate in a press-fit relationship with a transverse contact member.
